(19) United States
(12) Patent Application Publication
(10) Pub. No.: US 2018/0054489 A1
(43) Pub. Date: Feb. 22, 2018

(54) CONTROL DEVICE AND CONTROL METHOD

(71) Applicant: FUJITSU LIMITED, Kawasaki-shi (JP)

(72) Inventors: Atsushi KUBOTA, Yokohama (JP); Yasuhiko Kanemasa, Kawasaki (JP); Hiromu MATSUMOTO, Yanai (JP); TOMONORI YAMASHITA, Yokohama (JP); YUKIHIKO FURUMOTO, Kawasaki (JP)

(73) Assignee: FUJITSU LIMITED, Kawasaki-shi (JP)

(21) Appl. No.: 15/667,003

(22) Filed: Aug. 2, 2017

(30) Foreign Application Priority Data
Aug. 16, 2016 (JP) 2016-159730

(51) Int. Cl. H04L 29/08; H04L 12/58

(52) U.S. Cl. CPC H04L 67/125; H04L 41/20; H04L 51/10

(57) ABSTRACT

A control device includes a processor configured to generate, in a learning phase, an operation model by using application information regarding an application operated at one terminal of terminals and operation information indicating an input operation performed at the one terminal. The one terminal communicates with one of servers in a remote desktop system. The operation information is input to the operation model. The application information is to be output from the operation model. The processor is configured to identify, in an operation phase, first application information corresponding to first operation information indicating a first input operation performed at a first terminal of the terminals by using the generated operation model. The processor is configured to control a parameter of communication between the first terminal and a first server of the servers depending on the first application information. The first server communicates with the first terminal.

### CROSS-REFERENCE TO RELATED APPLICATION

This application is based upon and claims the benefit of priority of the prior Japanese Patent Application No. 2016-159730, filed on Aug. 16, 2016, the entire contents of which are incorporated herein by reference.

### FIELD

The embodiment discussed herein is related to a control device and a control method.

### BACKGROUND

In a remote desktop system of related art, a technology is known in which resource information on a terminal device is added to screen information to be managed by a server.

In a system that presents a screen of a business system to an operator, a technology is known in which importance of a screen of an application is determined based on an operation on the application or a change in state of the application.

In a remote desktop system of related art, a technology is known in which a response time from an input operation at a terminal to a drawing process on the screen in response to the input operation is calculated.

Related technologies are disclosed in, for example, Japanese Laid-Open Patent Publication No. 2007-219790, International Publication Pamphlet No. WO 2013-042180, and Japanese Laid-Open Patent Publication No. 2015-011653.

### SUMMARY

According to an aspect of the present invention, provided is a control device including a memory and a processor coupled to the memory. The processor is configured to generate, in a learning phase, an operation model by using application information regarding an application operated at one terminal of terminals and operation information indicating an input operation performed at the one terminal. The one terminal communicates with one of servers in a remote desktop system. The operation information is input to the operation model. The application information is to be output from the operation model. The processor is configured to identify, in an operation phase, first application information corresponding to first operation information indicating a first input operation performed at a first terminal of the terminals by using the generated operation model. The processor is configured to control a parameter of communication between the first terminal and a first server of the servers depending on the first application information. The first server communicates with the first terminal.

The object and advantages of the disclosure will be realized and attained by means of the elements and combinations particularly pointed out in the claims. It is to be understood that both the foregoing general description and the following detailed description are exemplary and explanatory and are not restirctive of the disclosure, as claimed.

### BRIEF DESCRIPTION OF DRAWINGS

FIG. 1 is a diagram illustrating a configuration of a remote desktop system according to an embodiment;

FIG. 2 is a diagram illustrating data transmitted and received between a terminal and a server;

FIG. 3 is a diagram illustrating a functional configuration of a control device according to the embodiment;

FIG. 4 is a diagram illustrating an example of an operation log;

FIG. 5 is a diagram illustrating a drawing process in the terminal;

FIG. 6 is a diagram illustrating an example of a used-application log;

FIG. 7 is a diagram illustrating an example of a connection list;

FIG. 8 is a diagram illustrating an example of learning input data;

FIG. 9 is a diagram illustrating an example of an operation model;

FIG. 10 is a diagram illustrating an example of unclassified input data;

FIG. 11 is a diagram illustrating an example of a classified application log;

FIG. 12 is a diagram illustrating an example of an importance list;

FIG. 13 is a diagram illustrating a process of controlling a priority of communication data;

FIG. 14 is a diagram illustrating a configuration of a computer which serves as the control device according to the embodiment;

FIG. 15 is a flowchart illustrating an example of a learning phase process according to the embodiment;

FIG. 16 is a flowchart illustrating an example of an operation phase process according to the embodiment; and

FIG. 17 is a diagram illustrating a process of controlling a communication band between a terminal and a server according to a modification.

### DESCRIPTION OF EMBODIMENT

In a remote desktop system in which a terminal and a server are coupled to each other via a network, a response time varies depending on a communication band, a congestion situation, and a data transmission amount of the network. The response time is a time distance between a time when the terminal transmits a request to the server and a time when the terminal receives a response from the server. That is, in a remote desktop system, the communication band, the congestion situation, the data transmission amount and the like of the network may influence the operability of the terminal.

The required degree of the operability of the terminal varies by applications. For example, in a computer-aided design (CAD) application, a relatively high image quality, relatively high responsiveness, and relatively high smoothness of screen display (e.g., high frame rate) are required. For example, in a Web browser, the relatively high responsiveness is required, but in many cases, the required image quality and the required smoothness of screen display are lower than the CAD application.

In an application for reproducing a moving picture, high smoothness of screen display is required after the reproduction of the moving picture starts, but the required responsiveness may be relatively low.

Therefore, depending on the application, the parameters for communication between the terminal and the server are preferably controlled to increase the operability of the terminal.

Hereinafter, an embodiment will be described in detail with reference to the accompanying drawings.

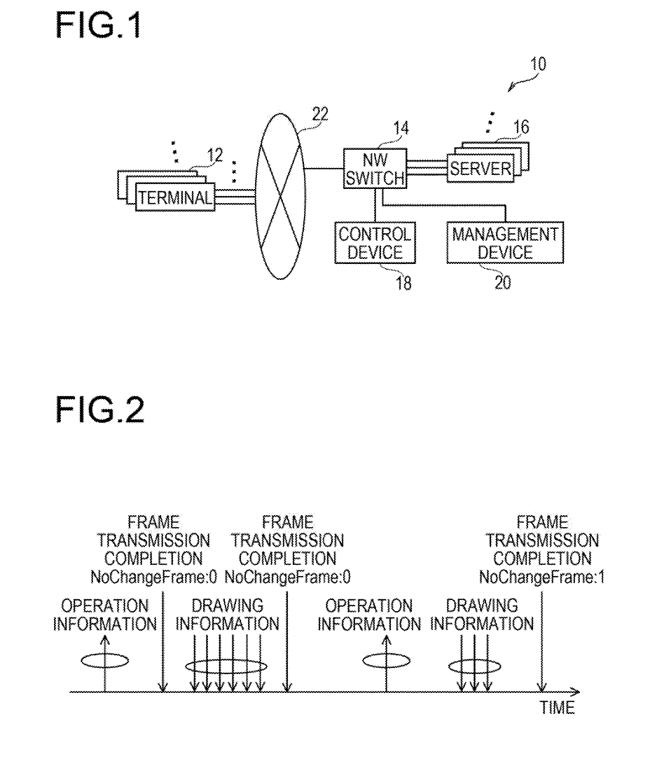

The configuration of a remote desktop system 10 according to the embodiment will be described with reference to FIG. 1. As illustrated in FIG. 1, the remote desktop system 10 includes terminals 12, a network (NW) switch 14, servers 16, a control device 18, and a management device 20.

The terminals 12 and the NW switch 14 are coupled to a network 22. The servers 16, the control device 18, and the management device 20 are coupled to the NW switch 14. With this configuration, the terminals 12, the servers 16, the control device 18, and the management device 20 are communicable with each other through the NW switch 14 and the network 22. The servers 16, the control device 18, and the management device 20 are communicable with each other through the NW switch 14.

At a terminal 12, an input operation such as a key input with a keyboard, movement of a mouse, a click of a mouse button, or the like is performed by a user, and operation information indicating the input operation is transmitted from the terminal 12 to a server 16.

The server 16 receives the operation information transmitted from the terminal 12, executes a process in response to the input operation indicated by the received operation information, and transmits drawing information indicating an instruction of drawing a screen representing a processing result to the terminal 12. The process in response to the input operation may include various processes which a computer executes in response to the input operation, for example, display of characters in response to the key input, movement of a mouse pointer in response to the movement of the mouse, and scroll of the screen.

The terminal 12 receives the drawing information transmitted from the server 16 and performs the drawing process based on the received drawing information to update the screen display of the terminal 12. The above processing is repeated, and as a result, the screen display of the terminal 12 is updated in accordance with the operation information indicating the input operation at the terminal 12.

An implementation method of a remote desktop in the remote desktop system 10 is not particularly limited. For example, the implementation method of the remote desktop may be a method in which the terminal 12 and the server 16 correspond to each other one to one or a method in which the terminal 12 and a virtual machine running on the server 16 correspond to each other one to one. Further, for example, the implementation method of the remote desktop may be a method in which a plurality of terminals 12 are coupled to one operating system (OS) running on the server 16, like remote desktop services (RDS) of Microsoft (registered trademark).

The NW switch 14 has a port mirroring function and mirrors communication data transmitted and received between the terminal 12 and the server 16 to a port coupled to the control device 18. The control device 18 receives the communication data mirrored by the NW switch 14. The control device 18 will be described in detail later.

The management device 20 has a function of a software defined network (SDN) controller and performs, in the NW switch 14, setting for the communication between the terminal 12 and the server 16 under the control of the control device 18.

Subsequently, an example of the communication data transmitted and received between the terminal 12 and the server 16 will be described with reference to FIG. 2.

In the example illustrated in FIG. 2, the upward arrow indicates the communication data transmitted from the terminal 12 to the server 16. The communication data transmitted from the terminal 12 to the server 16 includes the operation information.

In the example illustrated in FIG. 2, the downward arrow indicates the communication data transmitted from the server 16 to the terminal 12. The communication data transmitted from the server 16 to the terminal 12 includes the drawing information. The drawing information includes commands indicating details of the process of drawing the screen. When the drawing process includes drawing of a new screen, the drawing information includes image data to be drawn. The drawing information includes frame transmission completion data having a command indicating that a frame transmission is completed. The frame transmission completion data indicates that a transmission of the drawing information for displaying one frame of the screen is completed. That is, the drawing information transmitted between one frame transmission completion data and the subsequent frame transmission completion data corresponds to the drawing information for displaying the screen for one frame.

In the embodiment, when the screen displayed on the terminal 12 is not updated, the server 16 does not transmit the frame transmission completion data. When the next update of the screen occurs and the server 16 thus transmits the frame transmission completion data, the server 16 specifies the number of frames, for which the frame transmission completion data is not transmitted, in a parameter “NoChangeFrame” to transmit the number of frames. That is, the parameter “NoChangeFrame” indicates the number of frames, for which the screen is not updated, immediately before. When the frame transmission completion data is transmitted for every frame, the value of “NoChangeFrame” is 0. Since the communication data transmitted and received between the terminal 12 and the server 16 is disclosed in Japanese Laid-Open Patent Publication No. 2015-011653, detailed descriptions thereof will be omitted.

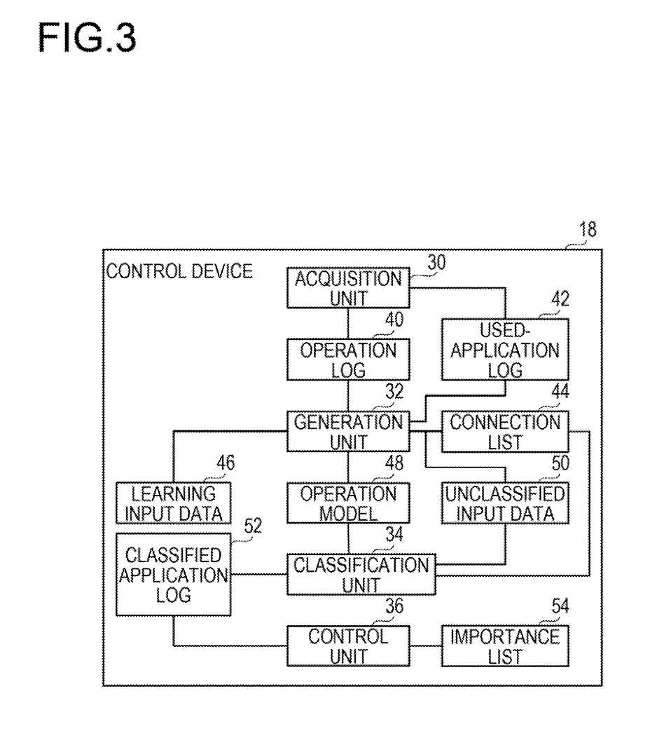

Subsequently, a functional configuration of the control device 18 according to the embodiment will be described with reference to FIG. 3. As illustrated in FIG. 3, the control device 18 includes an acquisition unit 30, a generation unit 32, a classification unit 34, and a control unit 36. An operation log 40, a used-application log 42, a connection list 44, learning input data 46, an operation model 48, unclassified input data 50, a classified application log 52, and an importance list 54 are memorized in a predetermined memory area of the control device 18.

The control device 18 according to the embodiment generates the operation model 48 by performing machine learning and identifies an application type by using the generated operation model 48. Hereinafter, a phase of generating the operation model 48 by performing the machine learning will be referred to as a “learning phase”, and a phase of identifying an application type by using the operation model 48 generated by the learning phase will be referred to as an “operation phase”.

In the learning phase, the acquisition unit 30 acquires the operation information and the drawing information, which is transmitted and received between the terminal 12 and the server 16 and mirrored by the NW switch 14. In the embodiment, the acquisition unit 30 acquires the operation information and the drawing information during a predetermined period (e.g., 1 hour) as the learning phase, and accumulates and memorizes the acquired operation information and drawing information in the operation log 40.

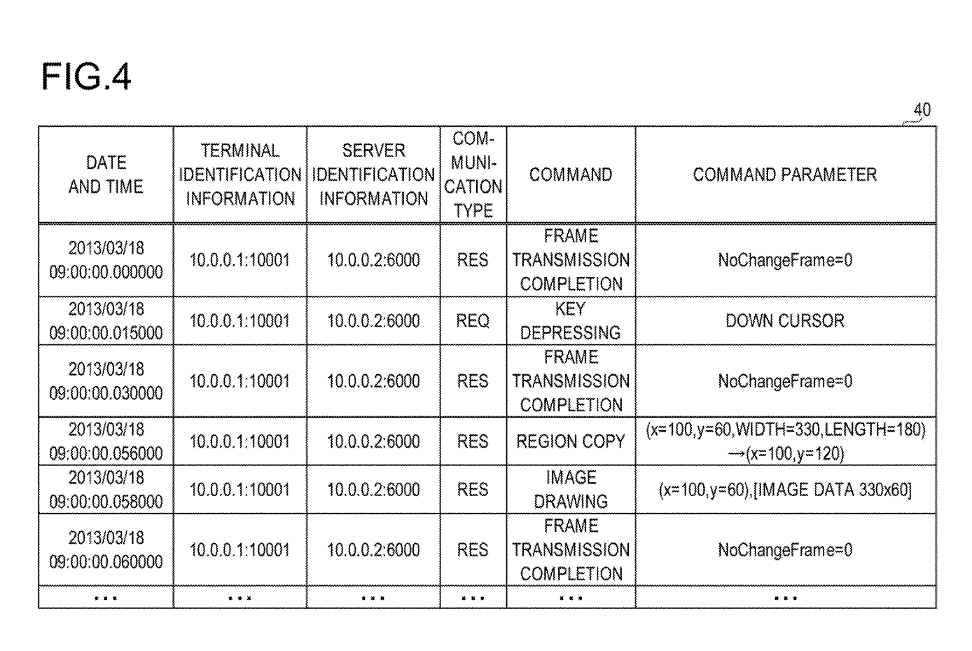

FIG. 4 illustrates an example of the operation log 40. As illustrated in FIG. 4, in the operation log 40, a date and time, terminal identification information, server identification information, a communication type, a command, and a command parameter are memorized. In the date and time, a date and time when the data is transmitted are memorized. In the terminal identification information, an internet protocol (IP) address and a port number of the terminal 12 are memorized. In the server identification information, an IP address and a port number of the server 16 are memorized. In the communication type, information indicating a request (marked as “REQ” in the example of FIG. 4) from the terminal 12 to the server 16 or a response (marked as “RES” in the example of FIG. 4) from the server 16 to the terminal 12 is memorized. In the command, contents of the command which is an instruction included in the data are memorized. In the command parameter, a parameter of the command is memorized.

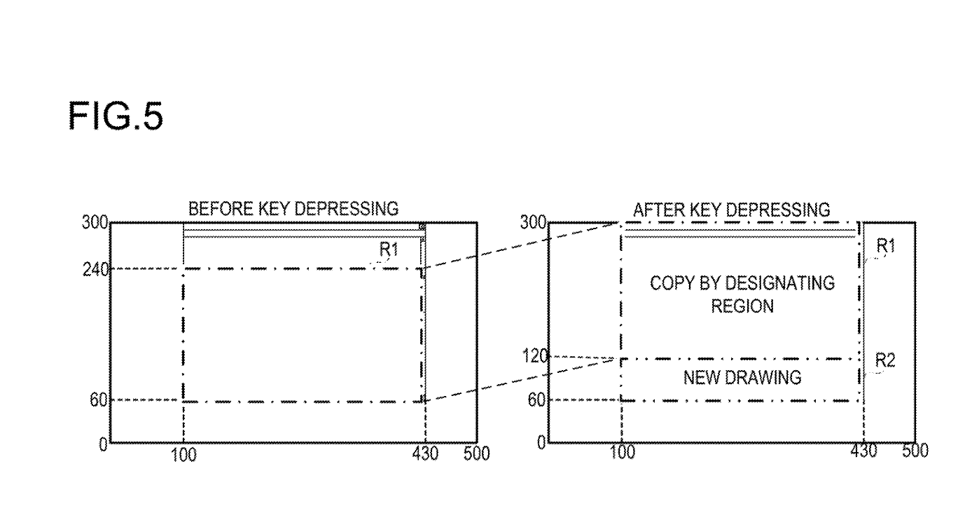

The example of FIG. 4 illustrates the operation log 40 when the input operation and the drawing process illustrated in FIG. 5 are performed at the terminal 12. FIG. 5 is a diagram illustrating an example of an image drawn in a display unit of the terminal 12. As illustrated in FIG. 5, the example of FIG. 4 illustrates a log when the user depresses a down-arrow key at the terminal 12 while the user browses a website with a web browser. Depending on a scroll amount of the web browser in response to the depression of the down-arrow key, a region R1 expressed by a chain line in FIG. 5 is copied to be drawn at a position above a position before the down-arrow key is depressed. Further, depending on the scroll amount of the web browser in response to the depression of the down-arrow key, a region R2 expressed by a two-dot chain line in FIG. 5 is newly drawn.

Also in the operation phase, the acquisition unit 30 acquires the operation information and the drawing information, which is transmitted and received between the terminal 12 and the server 16 and mirrored by the NW switch 14. Further in the learning phase, the acquisition unit 30 acquires, from the server 16, information on the application operated by the user at the terminal 12, every predetermined period. In the embodiment, the acquisition unit 30 acquires a name of an active window (e.g., a window displayed on the foreground) at the terminal 12 as the information on the application. The acquisition unit 30 may acquire the name of the active window from the terminal 12 or from the data mirrored by the NW switch 14.

The acquisition unit 30 identifies an application type corresponding to the acquired window name, for example, on the basis of a table prestored in the memory, in which window names are respectively associated with application types. The acquisition unit 30 memorizes each combination of the terminal identification information and the server identification information in the used-application log 42 in association with the identified application type.

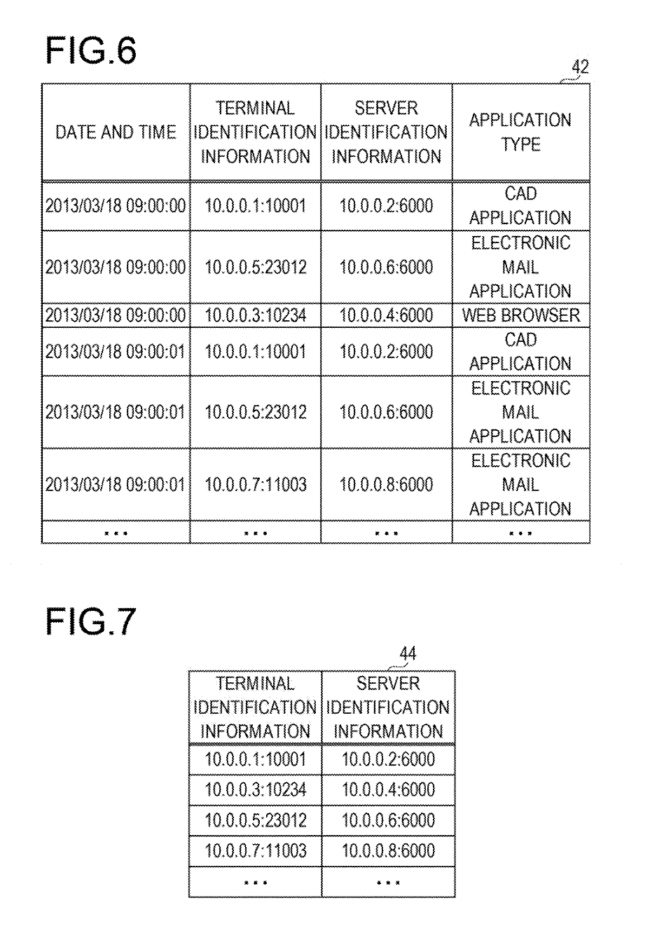

FIG. 6 illustrates an example of the used-application log 42. As illustrated in FIG. 6, in the used-application log 42, a date and time, terminal identification information, server identification information, and an application type are memorized. In the date and time, a date and time when the information on the application is acquired from the server are memorized. In the terminal identification information and the server identification information, the same information as the terminal identification information and the server identification information in the operation log 40 are memorized. In the application type, an application type identified as described above is memorized. In the example of FIG. 6, the application type is memorized every one second for each combination of the terminal identification information and the server identification information.

A technique for identifying an application type is not limited to the above-described example. For example, the acquisition unit 30 may acquire, from the server 16, a process name of an application operated by the user at the terminal 12, at a predetermined interval. Then, the acquisition unit 30 may identify an application type, which corresponds to the acquired process name.

The generation unit 32 extracts a combination of the terminal identification information and the server identification information from the operation log 40 and memorizes the extracted combination in the connection list 44 in each phase. At the time of memorizing the combination in the connection list 44, the generation unit 32 memorizes the combination of the terminal identification information and the server identification information without overlapping records. FIG. 7 illustrates an example of the connection list 44. As illustrated in FIG. 7, in the connection list 44, combinations of the terminal identification information and the server identification information are memorized in the operation log 40 without overlaps. Hereinafter, a combination of the terminal identification information and the server identification information will also be referred to as a “connection”.

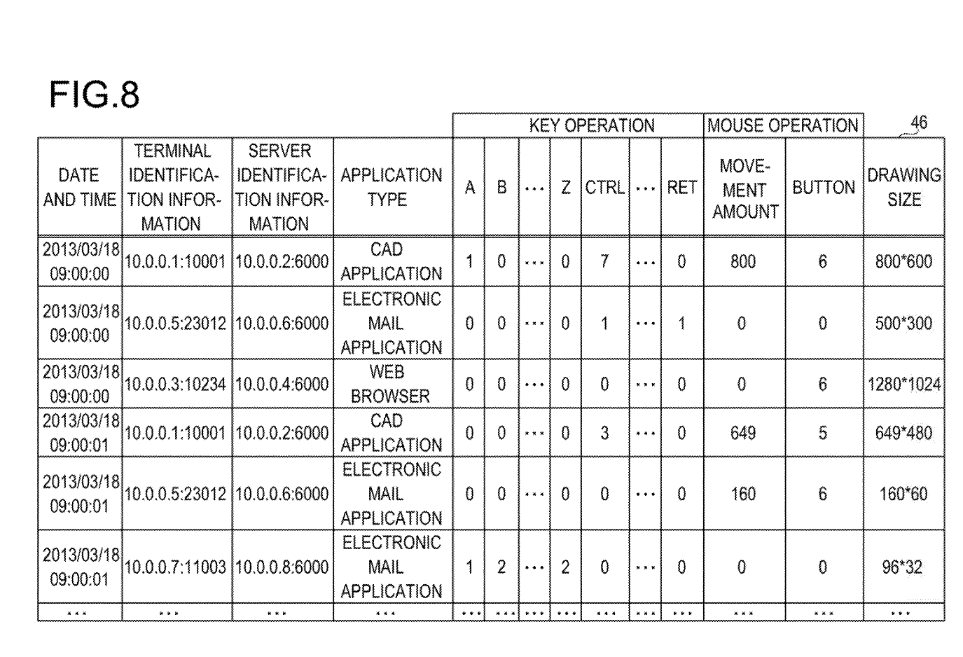

The generation unit 32 generates the learning input data 46 by using the operation log 40, the used-application log 42, and the connection list 44 in the learning phase. FIG. 8 illustrates an example of the learning input data 46.

As illustrated in FIG. 8, the generation unit 32 analyzes and aggregates the command and the command parameter in the operation log 40 for each connection in the connection list 44 and for every predetermined period (every one second in the example of FIG. 8), and memorizes a key operation, a mouse operation, and a drawing size in the learning input data 46.

The key operation indicates the number of depression times when the user depresses each key of a keyboard within a predetermined period at the terminal 12. The mouse operation includes a movement amount of a mouse cursor within a predetermined period resulted from movement of the mouse caused by the user at the terminal 12 and the number of click times of a button of the mouse within the predetermined period performed by the user. The drawing size indicates the size of a drawing region in the display unit of the terminal 12. Data displayed within the drawing region is updated as a result of the drawing process performed in the display unit of the terminal 12 within a predetermined period in response to the input operation at the terminal 12.

The generation unit 32 identifies, for each connection of the learning input data 46, an application type associated with a date and time memorized in the date and time column of the used-application log 42 and memorizes the identified type in the application type of the learning input data 46.

The generation unit 32 performs machine learning by using the learning input data 46 to generate the operation model 48. An input to the operation model 48 is operation information and a size of the drawing region. An output from the operation model 48 is an application type. In the embodiment, as an example, an input to the operation model 48 generated by the generation unit 32 includes the key operation, the mouse operation, and the drawing size illustrated in FIG. 8 and an output from the operation model 48 generated by the generation unit 32 is an application type. Since known techniques including, for example, a neural network, a support vector machine (SVM), a k-nearest neighbor discrimination, and Bayesian classification may be applied as a modeling technique based on machine learning, detailed descriptions thereof herein will be omitted.

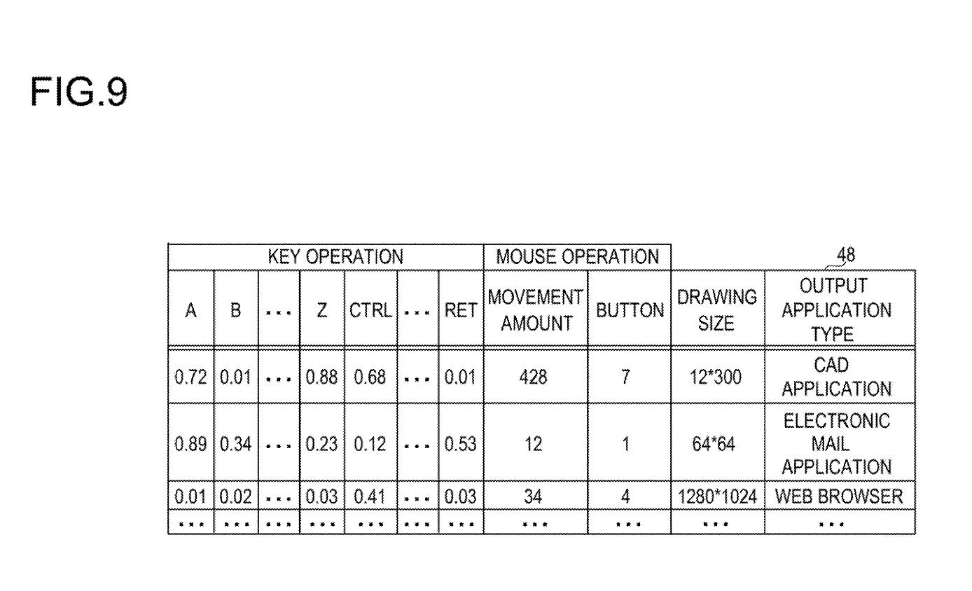

FIG. 9 illustrates an example of the operation model 48. As illustrated in FIG. 9, in the operation model 48, information for classifying the key operation, the mouse operation, and the drawing size into application types and outputting the application types is memorized.

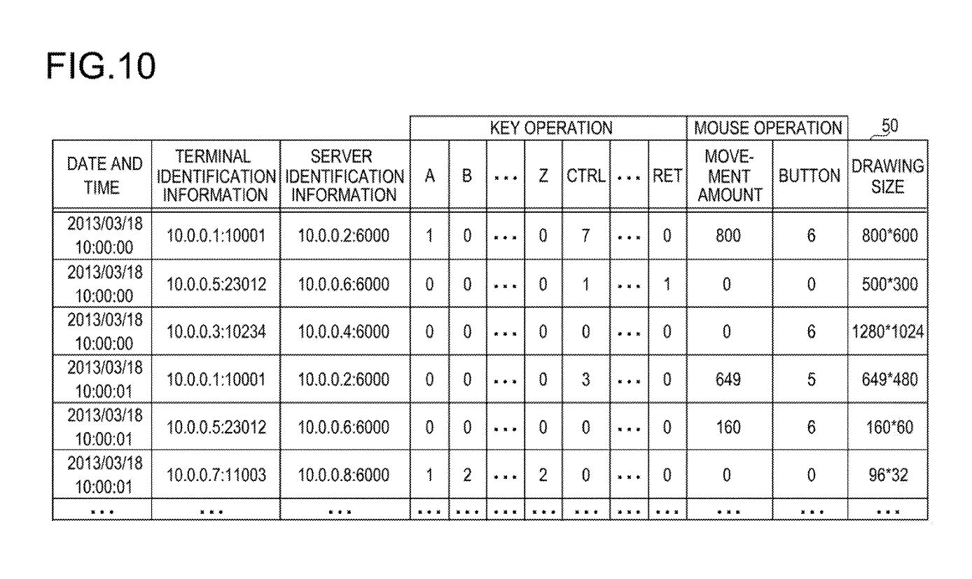

In the operation phase, the generation unit 32 generates the unclassified input data 50 by using the operation log 40 and the connection list 44. FIG. 10 illustrates an example of the unclassified input data 50. As illustrated in FIG. 10, in the unclassified input data 50, the same information as the learning input data 46 is memorized, except that an application type is not memorized.

Similarly to the learning phase, the generation unit 32 analyzes and aggregates the command and the command parameter in the operation log 40 for each connection in the connection list 44 and for every predetermined period, and memorizes a key operation, a mouse operation, and a drawing size in the unclassified input data 50.

In the operation phase, the classification unit 34 inputs the unclassified input data 50 in the operation model 48 for each connection memorized in the connection list 44 and for every predetermined period. As a result, for each connection and for every predetermined period, the classification unit 34 identifies the application type output from the operation model 48 as an application type of the application operated at the terminal 12.

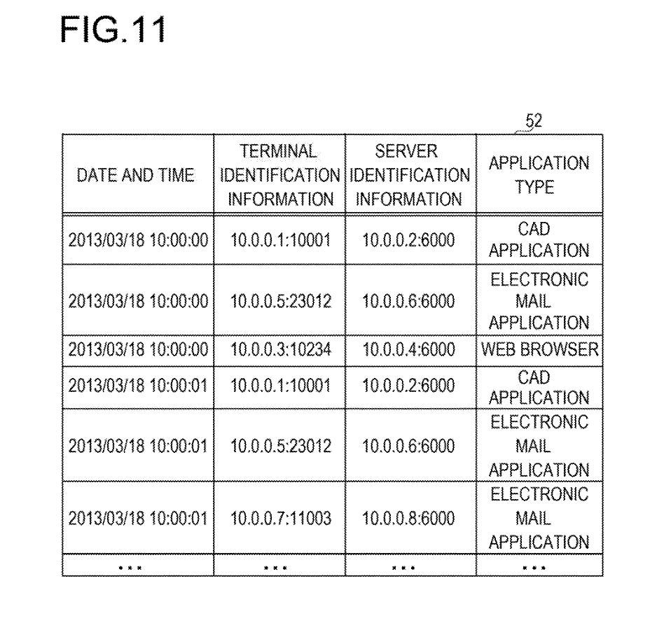

As an example, as illustrated in FIG. 11, the classification unit 34 memorizes the connection and the identified application type corresponding to the connection in the classified application log 52 for each connection and for every predetermined period.

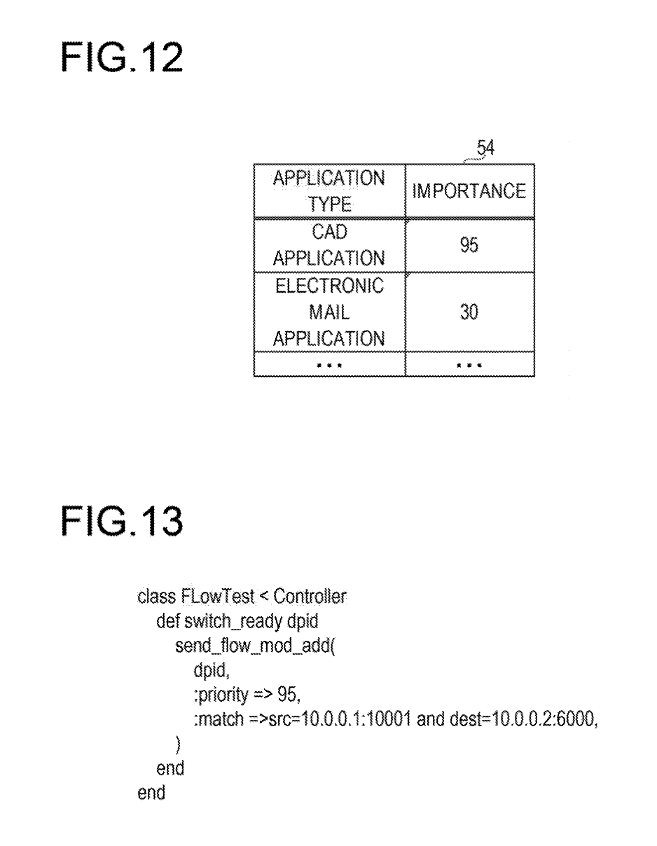

The control unit 36 controls the parameter of the communication between the terminal 12 and the server 16 on the basis of the application type identified by the classification unit 34 and the importance list 54. As a result, the control unit 36 controls Quality of Service (QoS) of the communication between the terminal 12 and the server 16. FIG. 12 illustrates an example of the importance list 54. As illustrated in FIG. 12, in the importance list 54, predetermined importance is memorized for each application type. In the example of FIG. 12, it is illustrated that the importance of a CAD application is higher than that of an electronic mail application.

In the embodiment, the control unit 36 controls the parameter of the communication between the terminal 12 and the server 16 for each connection depending on the importance corresponding to the application type, whenever the application type identified by the classification unit 34 changes. Specifically, the control unit 36 controls communication data having the higher importance to be preferentially transmitted and received by setting the priority of the communication data between the terminal 12 and the server 16 as the importance.

FIG. 13 illustrates an example of a command to control the priority to be set in the NW switch 14 through the management device 20 by the control unit 36. The command in the example illustrated in FIG. 13 controls the priority of the communication data transmitted from the terminal 12 to the server 16 as “95”. The terminal 12 has “10.0.0.1:10001” as the combination of the IP address and the port number. The server 16 has “10.0.0.2:6000” as the combination of the IP address and the port number.

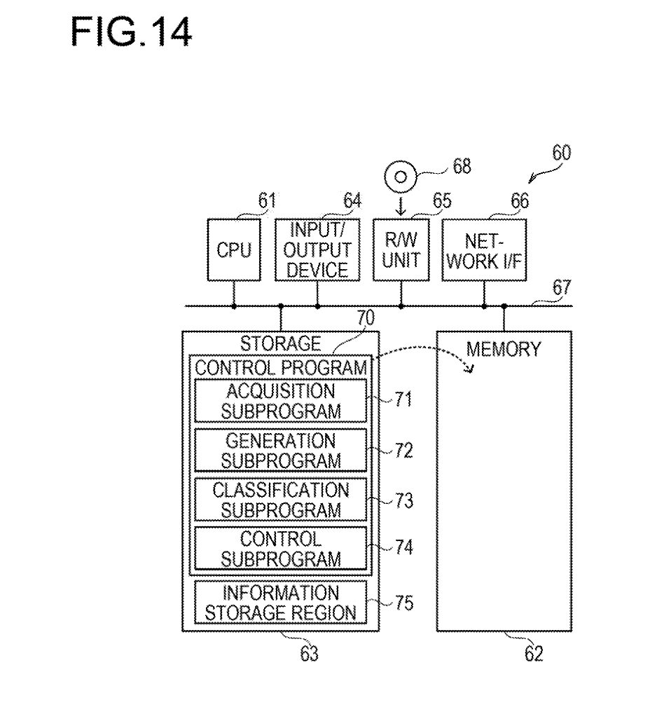

The control device 18 may be implemented by, for example, a computer 60 illustrated in FIG. 14. The computer 60 includes a central processing unit (CPU) 61, a memory 62 as a temporary storage region, and a non-volatile storage 63. The computer 60 includes an input/output device 64 including a display device and an input device. The computer 60 includes a read/write (R/W) unit 65 controlling reading and writing data from and to a recording medium 68 and a network interface (I/F) 66 coupled to a network. The CPU 61, the memory 62, the storage 63, the input/output device 64, the R/W unit 65, and the network I/F 66 are coupled to each other through a bus 67.

The storage 63 may be implemented by a hard disk drive (HDD), a solid state drive (SSD), a flash memory, etc. The storage 63 as a storage medium stores a control program 70 for making the computer 60 serve as the control device 18. The control program 70 includes an acquisition subprogram 71, a generation subprogram 72, a classification subprogram 73, and a control subprogram 74. Further, the storage 63 includes an information storage region 75 for storing the operation log 40, the used-application log 42, the connection list 44, the learning input data 46, the operation model 48, the unclassified input data 50, the classified application log 52, and the importance list 54.

The CPU 61 reads the control program 70 from the storage 63 to load the read control program 70 to the memory 62, and executes the processes of the control program 70. The CPU 61 executes the acquisition subprogram 71 to serve as the acquisition unit 30 illustrated in FIG. 3. The CPU 61 executes the generation subprogram 72 to serve as the generation unit 32 illustrated in FIG. 3. The CPU 61 executes the classification subprogram 73 to serve as the classification unit 34 illustrated in FIG. 3. The CPU 61 executes the control subprogram 74 to serve as the control unit 36 illustrated in FIG. 3. As a result, the computer 60 that executes the control program 70 serves as the control device 18.

Functions implemented by the control program 70 may also be implemented by, for example, a semiconductor integrated circuit, more specifically, an application specific integrated circuit (ASIC), etc.

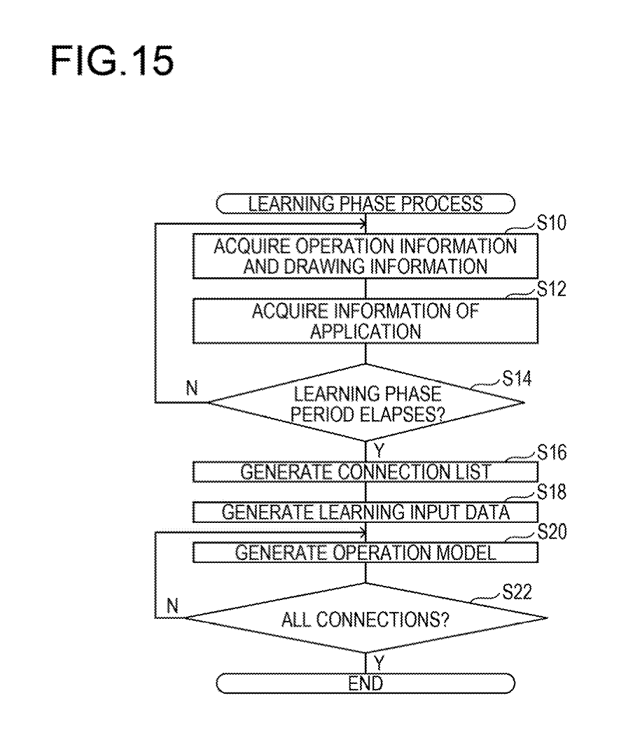

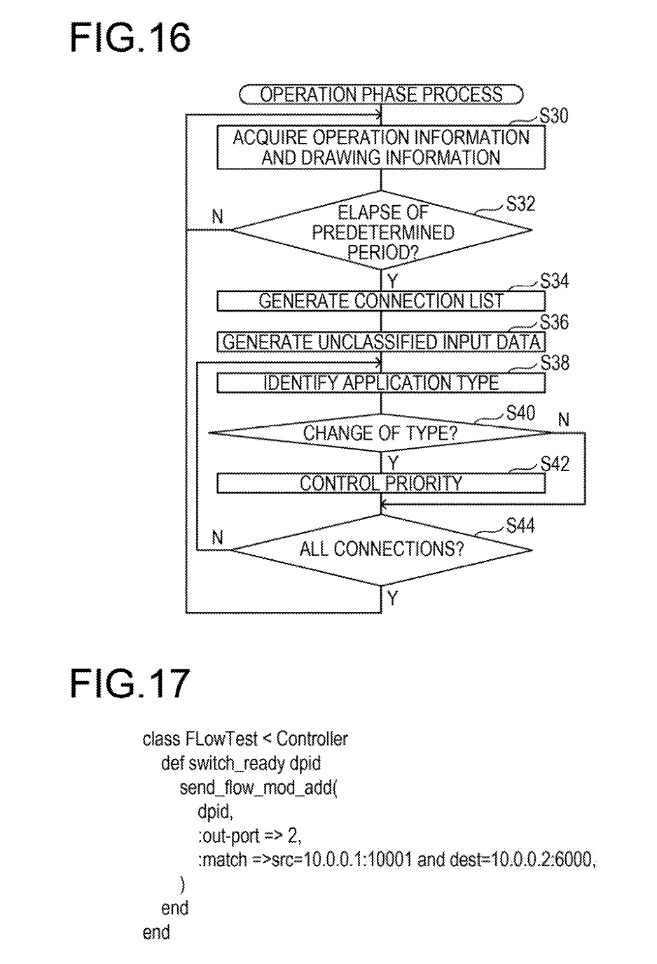

Subsequently, an operation of the control device 18 according to the embodiment will be described. The control device 18 executes the control program 70 to perform a learning phase process illustrated in FIG. 15 and an operation phase process illustrated in FIG. 16. The learning phase process illustrated in FIG. 15 is performed by the CPU 61, for example, in a case where the user inputs an instruction of an execution start through the input device of the input/output device 64, etc.

For example, the user inputs the instruction of the execution start when the operation model 48 is not memorized in the storage 63 (that is, when the operation model 48 is prepared for the first time). Further, for example, in a case where the application types are changed, which includes a case where a new application type is added and a case where an existing application type is deleted, the user inputs the instruction of the execution start. In addition, for example, the user inputs the instruction of the execution start in a case where a communication band of the network between the terminal 12 and the server 16, processing performance of the server 16, or the like is changed.

The operation phase process illustrated in FIG. 16 is executed by the CPU 61, for example, in a case where the user inputs an instruction of the execution start through the input device of the input/output device 64, etc. For example, after the learning phase process is completed, the user inputs the instruction of the execution start. Further, for example, the CPU 61 may automatically perform the operation phase process after the learning phase process is completed.

In S10 of the learning phase process illustrated in FIG. 15, the acquisition unit 30 acquires the operation information and the drawing information transmitted and received between the terminal 12 and the server 16 and mirrored by the NW switch 14. The acquisition unit 30 memorizes the acquired operation information and drawing information in the operation log 40.

Next, in S12, as described above, the acquisition unit 30 acquires, from the server 16, information on the application operated by the user at the terminal 12. The acquisition unit 30 identifies an application type corresponding to the acquired information of the application and memorizes the application type in the used-application log 42 in association with the combination of the terminal identification information and the server identification information.

S10 and S12 are repeated during a predetermined period as the learning phase to memorize the operation log 40 and the used-application log 42 during the predetermined period in the storage 63. When the predetermined period elapses as the learning phase after starting the learning phase process, a determination result in S14 becomes affirmative and the process proceeds to S16.

In S16, combinations of the terminal identification information and the server identification information are extracted from the operation log 40 memorized by the repetition of S10 to generate the connection list 44. Next, in S18, as described above, the generation unit 32 analyzes and aggregates the command and the command parameter in the operation log 40 for each connection in the connection list 44 and for every predetermined period, and memorizes a key operation, a mouse operation, and a drawing size in the learning input data 46. The generation unit 32 identifies, for each connection of the learning input data 46, an application type associated with a date and time memorized in the date and time column of the used-application log 42 and memorizes the identified type in the application type of the learning input data 46.

S20 described below is repeatedly performed for each connection memorized in the connection list 44. S20 is performed for a new connection every time S20 is repeated.

In S20, the generation unit 32 extracts data corresponding to the new connection from the learning input data 46 and performs the machine learning by using the extracted data to generate the operation model 48. At the first time of the repetition, the generation unit 32 newly memorizes the generated operation model 48 in the storage 63. At the second time of the repetition and thereafter, the generation unit 32 adds the generated operation model 48 to the operation model 48 memorized in the storage 63.

In S22, the generation unit 32 determines whether S20 is performed for all the connections in the connection list 44. While the determination result is negative, the process returns to S20, and when the determination result becomes affirmative, the learning phase process ends.

In S30 of the operation phase process illustrated in FIG. 16, the acquisition unit 30 acquires the operation information and the drawing information transmitted and received between the terminal 12 and the server 16 and mirrored by the NW switch 14. The acquisition unit 30 memorizes the acquired operation information and drawing information in the operation log 40.

S30 is repeatedly performed during a predetermined period, and as a result, the operation log 40 is memorized in the storage 63 during the predetermined period. In the embodiment, S30 is repeatedly performed during the aggregation interval (one second in the embodiment) when the learning input data 46 is generated. When S30 is repeatedly performed during the predetermined period, the determination result in S32 becomes affirmative and the process proceeds to S34.

In S34, the generation unit 32 extracts combinations of the terminal identification information and the server identification information from the operation log 40 memorized by the repetition of S30 to generate the connection list 44. In S36, the generation unit 32 analyzes and aggregates the command and the command parameter in the operation log 40 for each connection in the connection list 44 and memorizes a key operation, a mouse operation, and a drawing size in the unclassified input data 50 as described above.

S38 to S42 described below are repeatedly performed for each connection memorized in the connection list 44. S38 to S42 are performed for a new connection every time S38 to S42 are repeated.

In S38, the classification unit 34 extracts the data corresponding to the new connection from the unclassified input data 50 and inputs the extracted data in the operation model 48 generated in the learning phase process. The classification unit 34 identifies an application type output from the operation model 48 as an application type corresponding to the new connection. The classification unit 34 memorizes a date and time, the new connection, and the identified application type corresponding to the new connection in the classified application log 52.

Next, in S40, it is determined whether the application type identified in S38 is different from the application type identified in S38 in the previous repetition. When the determination result is negative, the process proceeds to S44, and when the determination result is affirmative, the process proceeds to S42.

In S42, the control unit 36 refers to the importance list 54 to acquire the importance corresponding to the application type identified in S38. As described above, the control unit 36 controls the priority of the communication data transmitted and received between the terminal 12 and the server 16 corresponding to the new connection depending on the acquired importance.

In S44, the control unit 36 determines whether S38 to S42 are performed for all the connections in the connection list 44. While the determination result is negative, the process returns to S38, and when the determination result becomes affirmative, the process returns to S30.

As described above, according to the present embodiment, the operation model 48 is generated in the learning phase by using an application type of an application operated at the terminal 12 and operation information indicating an input operation at the terminal 12. An input to the operation model 48 is operation information and an output from the operation model 48 is an application type. In the operation phase, an application type corresponding to operation information acquired for each terminal 12 is identified by using the generated operation model 48. Then, the priority of the communication data transmitted between the terminal 12 and the server 16 is controlled depending on the application type. Therefore, the parameter of the communication between the terminal and the server may be controlled depending on the application type of the application used by the user at the terminal.

According to the embodiment, the input to the generated operation model 48 also includes a size of a drawing region in the display unit of the terminal 12. Data displayed within the drawing region is updated in response to the input operation. In this case, an application type corresponding to the operation information and the size of the drawing region acquired in the operation phase are identified by using the generated operation model 48. Therefore, the application type may be identified with high precision, as compared with the case where the application type corresponding to the operation information is identified by using the generated operation model 48.

In the embodiment, the input to the generated operation model 48 may be the operation information and does not include the size of the drawing region in the learning phase, and the output from the generated operation model 48 may be the application type. In this case, in the operation phase, an application type corresponding to the operation information acquired for each terminal 12 may be identified by using the generated operation model 48.

In the embodiment, instead of an application type, other information that may identify an application, such as a name of the application and a process name of the application may be used. In this case, a parameter of communication between the terminal 12 and the server 16 for each application is controlled.

In the embodiment described above, the priority of the communication data between the terminal 12 and the server 16 is used as the parameter of the communication, which is controlled depending on the importance of the application type, but the parameter is not limited thereto. For example, a communication band between the terminal 12 and the server 16 may be controlled as the parameter. In this case, for example, the communication band between the terminal 12 and the server 16 is extended as the importance of the application is higher.

Specifically, for example, it is assumed that the terminal 12 and the server 16 are coupled by communication lines of two communication bands of 12 megabit per second (Mbps) and 100 Mbps. In this case, for example, the communication line of 100 Mbps is controlled to be used for a communication which is identified to be performed between a server 16 and a terminal 12 at which an application of an application type having importance equal to or higher than a predetermined threshold value is operated. In this case, for example, the communication line of 12 Mbps is controlled to be used for a communication which is identified to be performed between a server 16 and a terminal 12 at which an application of an application type having importance lower than the predetermined threshold value is operated.

FIG. 17 illustrates an example of a command to control the communication band between the terminal 12 and the server 16 through the management device 20 by the control unit 36. FIG. 17 illustrates an example of a command to control communication data, which is transmitted from a terminal 12 having a combination of an IP address and a port number “10.0.0.1:10001” to a server 16 having a combination of an IP address and a port number “10.0.0.2:6000”, to be transmitted by using port #2. As such, for example, when the communication band varies depending on the port number used by the communication data, the communication band between the terminal 12 and the server 16 may be controlled through the command in the example of FIG. 17. The port number in this case, may be the number of a physical port or the number of a virtual port.

For example, a capacity of image data included in the drawing information transmitted from the server 16 to the terminal 12 may be controlled as the parameter, that is, a capacity of image data displayed in the display unit of the terminal 12 may be controlled. In this case, for example, the capacity is extended as the importance of the application is higher. In this case, for example, the capacity of the data may be controlled by controlling a resolution, a compression rate, and the like of the image data.

For example, a transmission interval of the drawing information transmitted from the server 16 to the terminal 12 may be controlled as the parameter, that is, a frame rate of the screen displayed in the display unit of the terminal 12 may be controlled. In this case, for example, the transmission interval is shortened, that is, the frame rate is increased as the importance of the application is higher.

For example, two or more parameters among a plurality of parameters described above may be controlled depending on the importance of the application type.

In addition, in the embodiment, it is described that the operation model 48 for each connection is generated in the learning phase and the generated operation models 48 are accumulated into one operation model 48, but the present disclosure is not limited thereto. For example, in a case where the applications used in all terminals 12 are of the same application type or the like, one operation model 48 may be generated by performing the machine learning by using the learning input data 46 including data of all connections.

In the embodiment, the case of controlling the parameter for each application type is described, but the present disclosure is not limited thereto. For example, the parameter may be controlled for each combination of an application type and a stage of work performed by using the application. Examples of the stage of work include performing design work, preparing an electronic mail, reading an electronic mail, and the like. In this case, the importance is memorized for each combination of an application type and a stage of work in the importance list 54. In this case, the stage of work is also memorized in the learning input data 46.

In the embodiment, the control program 70 is prestored (preinstalled) in the storage 63, but the present disclosure is not limited thereto. The control program 70 may be recorded in a recording medium to be provided. The recording medium includes a compact disc read-only memory (CD-ROM), a digital versatile disc read-only memory (DVD-ROM), a universal serial bus (USB) memory, a memory card, etc.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment of the present disclosure has been described in detail, it should be understood that the various changes, substitutions, and alterations could be made hereto without departing from the spirit and scope of the disclosure.

What is claimed is:

1. A non-transitory computer-readable recording medium having stored therein a program that causes a computer to execute a process, the process comprising:
generating, in a learning phase, an operation model by using application information regarding an application operated at one terminal of terminals and operation information indicating an input operation performed at the one terminal, the one terminal communicating with one of servers in a remote desktop system, the operation information being input to the operation model, the application information being to be output from the operation model;
identifying, in an operation phase, first application information corresponding to first operation information indicating a first input operation performed at a first terminal of the terminals by using the generated operation model; and
controlling a parameter of communication between the first terminal and a first server of the servers depending on the first application information, the first server communicating with the first terminal.

2. The non-transitory computer-readable recording medium according to claim 1, the process further comprising:
generating the operation model by also using a size of a drawing region in a display unit of the one terminal, data displayed within the drawing region being updated in response to the input operation performed at the one terminal, the size also being input to the operation model; and
identifying the first application information corresponding to the first operation information and a first size of a first drawing region by using the generated operation model, data displayed within the first drawing region being updated in response to the first input operation.

3. The non-transitory computer-readable recording medium according to claim 1, wherein
the parameter is at least one of a communication band between the first server and the first terminal, a priority of communication data transmitted between the first server and the first terminal, a capacity of image data included in drawing information transmitted from the first server to the first terminal, or a transmission interval of the drawing information.

4. A control device, comprising:
a memory; and
a processor coupled to the memory and the processor configured to:
generate, in a learning phase, an operation model by using application information regarding an application operated at one terminal of terminals and operation information indicating an input operation performed at the one terminal, the one terminal communicating with one of servers in a remote desktop system, the operation information being input to the operation model, the application information being to be output from the operation model;
identify, in an operation phase, first application information corresponding to first operation information indicating a first input operation performed at a first terminal of the terminals by using the generated operation model; and
control a parameter of communication between the first terminal and a first server of the servers depending on the first application information, the first server communicating with the first terminal.

5. The control device according to claim 4, wherein
the processor is configured to:
generate the operation model by also using a size of a drawing region in a display unit of the one terminal, data displayed within the drawing region being updated in response to the input operation performed at the one terminal, the size also being input to the operation model; and
identify the first application information corresponding to the first operation information and a first size of a first drawing region by using the generated operation model, data displayed within the first drawing region being updated in response to the first input operation.

6. The control device according to claim 4, wherein
the parameter is at least one of a communication band between the first server and the first terminal, a priority of communication data transmitted between the first server and the first terminal, a capacity of image data included in drawing information transmitted from the first server to the first terminal, or a transmission interval of the drawing information.

7. A control method, comprising:
generating by a computer, in a learning phase, an operation model by using application information regarding an application operated at one terminal of terminals and operation information indicating an input operation performed at the one terminal, the one terminal communicating with one of servers in a remote desktop system, the operation information being input to the operation model, the application information being to be output from the operation model;
identifying, in an operation phase, first application information corresponding to first operation information indicating a first input operation performed at a first terminal of the terminals by using the generated operation model; and
controlling a parameter of communication between the first terminal and a first server of the servers depending on the first application information, the first server communicating with the first terminal.

8. The control method according to claim 7, further comprising:
generating the operation model by also using a size of a drawing region in a display unit of the one terminal, data displayed within the drawing region being updated in response to the input operation performed at the one terminal, the size also being input to the operation model; and
identifying the first application information corresponding to the first operation information and a first size of a first drawing region by using the generated operation model, data displayed within the first drawing region being updated in response to the first input operation.

9. The control method according to claim 7, wherein
the parameter is at least one of a communication band between the first server and the first terminal, a priority of communication data transmitted between the first server and the first terminal, a capacity of image data included in drawing information transmitted from the first server to the first terminal, or a transmission interval of the drawing information.
